(19) United States
(12) Patent Application Publication
(10) Pub. No.: US 2023/0275468 A1
(43) Pub. Date: Aug. 31, 2023

(54) PHOTOELECTRIC TRANSMISSION ISOLATION POWER SUPPLY

(71) Applicant: SUZHOU KANGKAI ELECTRIC CO., LTD., Suzhou, Jiangsu (CN)

(72) Inventor: Yongfu SHEN, Suzhou, Jiangsu (CN)

(21) Appl. No.: 18/014,769

(22) PCT Filed: Dec. 30, 2020
(86) PCT No.: PCT/CN2020/141303

§ 371 Date: Jan. 6, 2023

(30) Foreign Application Priority Data
Jul. 8, 2020 (CN) 202010651055.4

(51) Int. Cl. H02J 50/30; H02J 50/80; H04B 10/80

(52) U.S. Cl. CPC H02J 50/30; H02J 50/80; H04B 10/807; G02B 27/30

(57) ABSTRACT

A photoelectric transmission isolation power supply is provided, including a transmitting end unit, an optical path straightener, and a receiving end unit. The transmitting end unit is configured for converting a power supply signal from an external power supply into an optical signal; the optical path straightener is configured for straightening the optical signal; the receiving end unit is configured for receiving the straightened optical signal, converting the straightened optical signal into an electrical signal, and providing the electrical signal to a load; the transmitting end unit includes an isolation transformer, a light-emitting source, and an AC/DC light-emitting power management circuit configured for performing AC-DC conversion and managing light-emitting efficiency of the light-emitting source; the optical path straightener includes a straightening mirror; the receiving end unit includes a photoelectric converter, and a DC/AC or DC/DC load management circuit configured for performing DC-AC conversion or DC conversion, and managing the load.

### CROSS-REFERENCE TO RELATED APPLICATIONS

This application claims priority to PCT Application No. PCT/CN2020/141303, having a filing date of Dec. 30, 2020, which claims priority to CN Application No. 202010651055.4, having a filing date of Jul. 8, 2020, the entire contents both of which are hereby incorporated by reference.

### FIELD OF TECHNOLOGY

The following relates to a power supply device.

### BACKGROUND

On Jun. 25, 2020, the successful networking of Zhangbei 500 kV Flexible DC Power Grid Test Demonstration Project means that the DC Ultra High Voltage networking technology tends to be mature, and the large-scale networking of DC UHV lines is about to begin. Followed by DC 800 kV and DC 1100 kV UHV power grid networking is about to advance. According to the technical requirements of DC 800 kV and DC 1100 kV UHV power grids, UHV equipment has higher and higher requirements for insulation withstand voltage stress of power supply equipment. The traditional isolation power supply has been unable to meet the requirements of insulation withstand voltage stress of UHV equipment, which will become a constraint to the progress of networking technology of DC 800 kV and DC 1100 kV UHV power grids. Therefore, in order to meet the requirements of insulation withstand voltage stress of power supply equipment and improve the operational reliability of UHV DC grid, it is necessary to design a new power supply device.

### SUMMARY

An aspect relates to a photoelectric transmission isolation power supply with a high insulating withstand voltage and high reliability, especially suitable for supplying energy to ultra high voltage equipment in ultra high voltage DC flexible networking.

To achieve the above purpose, a technical solution employed by the present disclosure is:

A photoelectric transmission isolation power supply, configured for powering a load, comprises:
a transmitting end unit, configured for obtaining a power supply signal from an external power supply and converting the power supply signal to an optical signal;
an optical path straightener, configured for straightening the optical signal and transmitting straightened optical signal; and
a receiving end unit, configured for receiving the straightened optical signal, converting the straightened optical signal to an electrical signal, and providing the electrical signal to the load;
the transmitting end unit and the receiving end unit are respectively arranged at two ends of the optical path straightener.

The transmitting end unit comprises a light-emitting source, and an AC/DC light-emitting power management circuit configured for performing AC-DC conversion and managing light-emitting efficiency of the light-emitting source, wherein the light-emitting source is connected to a DC side of the AC/DC light-emitting power management circuit.

The transmitting end unit further comprises an isolation transformer, wherein a primary side of the isolation transformer is connected to the external power supply, and a secondary side of the isolation transformer is connected to an AC side of the AC/DC light-emitting power management circuit.

The light-emitting source comprises a number of LEDs connected in parallel.

The optical path straightener comprises a straightening mirror, and an optical path transmission space is formed between the straightening mirror and the receiving end unit for transmission of the straightened optical signal.

The straightened optical signal has a transmission distance ranged from 0.1 to 1000 meters.

The optical path straightener further comprises a housing arranged outside the straightening mirror, and the optical path transmission space is formed in the housing.

The receiving end unit comprises a photoelectric converter, and a DC/AC or DC/DC load management circuit configured for performing DC-AC conversion or DC conversion and managing the load, wherein the photoelectric converter is connected to an input side of the DC/AC or DC/DC load management circuit, and the load is connected to an output side of the DC/AC or DC/DC load management circuit.

The receiving end unit further comprises a communication module configured for feeding back a working condition of the load to the transmitting end unit, and the communication module is connected to the DC/AC or DC/DC load management circuit.

The communication module is RS485 communication module.

Due to the use of the above technical solutions, the present disclosure has the following advantages over the conventional art: The present disclosure uses light as an energy transmission medium, which has advantages of long transmission distance, high insulating withstand voltage stress, strong short-circuit resistance, and safe and reliable in operation, etc., and is suitable for supplying energy for UHV equipment in UHVDC flexible networking.

### BRIEF DESCRIPTION

Some of the embodiments will be described in detail, with references to the following Figures, wherein like designations denote like members, wherein:

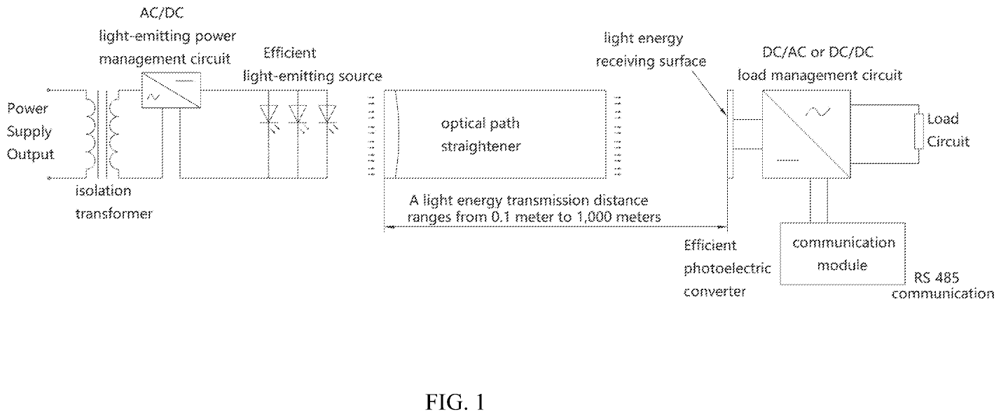

FIG. 1 is a principle diagram of a photoelectric transmission isolation power supply of the present disclosure.

### DETAILED DESCRIPTION

The present disclosure is further described below combining with embodiments shown in the accompanying drawings.

As shown in FIG. 1, a photoelectric transmission isolation power supply comprises a transmitting end unit, an optical path straightener, and a receiving end unit arranged in sequence. The two ends of the optical path straightener are its input end and output end, respectively, then the transmitting end unit and the receiving end unit are arranged at the two ends of the optical path straightener, that is, the transmitting end unit is arranged on the input side of the optical path straightener, and the receiving end unit is arranged on the output side of the optical path straightener.

The transmitting end unit is configured to obtain a power supply signal from an external power supply and convert the power supply signal to an optical signal. The transmitting end unit comprises an isolation transformer, an AC/DC light-emitting power management circuit and a light-emitting source, wherein the isolation transformer is configured for voltage conversion and voltage isolation, the AC/DC light-emitting power management circuit is configured for performing AC-DC conversion and managing light-emitting efficiency of the light-emitting source, and the light-emitting source is configured for emitting light, which is a conversion of an electrical signal to an optical signal. A primary side of the isolation transformer is connected to the external power supply, and a secondary side of the isolation transformer is connected to an AC side of the AC/DC light-emitting power management circuit, and the light-emitting source is connected to an DC side of the AC/DC light-emitting power management circuit. The light-emitting source comprises a number of high-efficiency LEDs connected in parallel.

The optical path straightener is configured for straightening the optical signal and transmitting straightened optical signal. The optical path straightener comprises a straightening mirror, and an optical path transmission space is formed between the straightening mirror and the receiving end unit for transmission of the straightened optical signal. The straightened optical signal has a transmission distance ranged from 0.1 to 1000 meters, and is transmitted in the air medium of the optical path transmission space. The optical path straightener further comprises a housing arranged outside the straightening mirror, and the optical path transmission space is formed in the housing.

The receiving end unit is configured for receiving the straightened optical signal, converting the straightened optical signal to an electrical signal, and providing the electrical signal to the load. The receiving end unit comprises a photoelectric converter, and a DC/AC or DC/DC load management circuit. The photoelectric converter is configured for converting the straightened optical signal to an electrical signal, and the DC/AC or DC/DC load management circuit is configured for performing DC-AC conversion or DC conversion and managing the load. The photoelectric converter is connected to an input side of the DC/AC or DC/DC load management circuit, and the load is connected to an output side of the DC/AC or DC/DC load management circuit. The receiving end unit further comprises a communication module, such as RS485 communication module. The communication module is connected to the DC/AC or DC/DC load management circuit, and is configured for feeding back a working condition of the load to the transmitting end unit, so that the load can be managed through the transmitting end.

The above-mentioned photoelectric transmission isolation power supply is configured to provide power to loads (such as UHV equipment). The principle is as follows: external AC power supply is isolated and transformed by the isolation transformer and then sent to the AC/DC light-emitting power management circuit, converted to a DC power supply signal and supplied to the light-emitting source, and the light-emitting source emits light under the management of the AC/DC light-emitting power management circuit, thereby converting electrical energy to light energy. The application of the isolation transformer can further improve the reliability of isolation voltage withstand. In order to maximize energy transmission, the optical path transmission uses an optical path straightener. The light emitted by the light-emitting source is straightened to a set of co-directional light rays and transmitted in the optical path transmission space. The straightened optical signal has a transmission distance ranged from 0.1 to 1000 meters, or more than 1000 meters (the transmission distance of the optical signal is the distance between the straightening mirror and the photoelectric converter), then the withstand voltage between the transmitting end unit and the receiving end unit of the power supply is from 10 kV to 10000 kV or greater than 10000 kV, that is, with the increase of the transmission distance of the optical signal, the voltage that can be withstood increases. The high-efficiency photoelectric converter receives the straightened optical signal output from the optical path transmission space, and converts the straightened optical signal to an electrical signal. In order to further improve the energy conversion efficiency, the receiving end uses a load management circuit to maintain the highest transmission efficiency, and the electrical signal converted by the photoelectric converter is provided to the load through the load management circuit.

The present disclosure realizes the use of light to transmit energy, effectively improves the insulation withstand voltage stress of the power supply equipment, thereby improving the operational reliability of the UHV DC power grids, and having advantages of strong short-circuit resistance and safe and reliable operation, etc. This technology will advance the progress of UHV DC grid and related technologies.

Although the present invention has been disclosed in the form of embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. (canceled)

2. A photoelectric transmission isolation power supply, configured for powering a load, wherein the photoelectric transmission isolation power supply comprises:
a transmitting end unit, configured for obtaining a power supply signal from an external power supply and converting the power supply signal to an optical signal;
an optical path straightener, configured for straightening the optical signal and transmitting straightened optical signal; and
a receiving end unit, configured for receiving the straightened optical signal, converting the straightened optical signal to an electrical signal, and providing the electrical signal to the load;
wherein the transmitting end unit and the receiving end unit are respectively arranged at two ends of the optical path straightener.

3. The photoelectric transmission isolation power supply according to claim 2, wherein transmitting end unit comprises a light-emitting source, and an AC/DC light-emitting power management circuit configured for performing AC-DC conversion and managing light-emitting efficiency of the light-emitting source, further wherein the light-emitting source is connected to a DC side of the AC/DC light-emitting power management circuit.

4. The photoelectric transmission isolation power supply according to claim 3, wherein the transmitting end unit further comprises an isolation transformer, and a primary side of the isolation transformer is connected to the external power supply, and a secondary side of the isolation transformer is connected to an AC side of the AC/DC light-emitting power management circuit.

5. The photoelectric transmission isolation power supply according to claim 3, wherein light-emitting source comprises a plurality of LEDs connected in parallel.

6. The photoelectric transmission isolation power supply according to claim 2, wherein optical path straightener comprises a straightening mirror, and an optical path transmission space is formed between the straightening mirror and the receiving end unit for transmission of the straightened optical signal.

7. The photoelectric transmission isolation power supply according to claim 6, wherein the straightened optical signal has a transmission distance ranged from 0.1 to 1000 meters.

8. The photoelectric transmission isolation power supply according to claim 6, wherein optical path straightener further comprises a housing arranged outside the straightening mirror, and the optical path transmission space is formed in the housing.

9. The photoelectric transmission isolation power supply according to claim 2, wherein the receiving end unit comprises a photoelectric converter, and a DC/AC or DC/DC load management circuit configured for performing DC-AC conversion or DC conversion and managing the load, further wherein the photoelectric converter is connected to an input side of the DC/AC or DC/DC load management circuit, and the load is connected to an output side of the DC/AC or DC/DC load management circuit.

10. The photoelectric transmission isolation power supply according to claim 9, wherein the receiving end unit further comprises a communication module configured for feeding back a working condition of the load to the transmitting end unit, and the communication module is connected to the DC/AC or DC/DC load management circuit.

11. The photoelectric transmission isolation power supply according to claim 10, wherein the communication module is an RS485 communication module.
